(19) United States
(12) Patent Application Publication
(10) Pub. No.: US 2026/0246887 A1
(43) Pub. Date: Aug. 20, 2026

(54) COLOR CALIBRATION ADJUSTMENT USING EFFECTIVE INK DROP WEIGHT

(71) Applicant: HEWLETT-PACKARD DEVELOPMENT COMPANY, L.P., Spring, TX (US)

(72) Inventors: Pere ESTERRI PEDRA, Sant Cugat del Valles (ES); Jordi SENDER BELETA, Sant Cugat del Valles (ES); Jan MOROVIC, Reading (GB); Peter MOROVIC, Sant Cugat del Valles (ES)

(73) Assignee: HEWLETT-PACKARD DEVELOPMENT COMPANY, L.P., Spring, TX (US)

(21) Appl. No.: 19/474,982

(22) PCT Filed: Apr. 25, 2023
(86) PCT No.: PCT/US2023/019841

§ 371 Date: Oct. 13, 2025

(51) Int. Cl. H04N 1/60; B41J 3/44; B41J 29/393; G01J 3/28

(52) U.S. Cl. CPC H04N 1/6044; B41J 3/44; B41J 29/393; G01J 3/28; H04N 1/605; B41J 2029/3935

(57) ABSTRACT

In example implementations, a method and system of color calibration adjustment are provided. The system includes a printing system having an output; an ink drop weight (IDW) sensor connected to the printing system; a spectrophotometer connected to the printing system; and a processor connected to the printing system, the ink drop weight sensor, and the spectrophotometer to determine an effective ink drop weight (elDW) and modify the output of the printing system based on differences in the elDW (AelDWs) between a previous reference state of the printing system and a current state of the printing system.

### BACKGROUND

Color calibration is typically a dedicated, off-production process during which a series of dedicated colorant patches are printed and measured with a color measurement device, where adjustments are subsequently made based on the measurements and previous reference measurements. The adjustments compensate for a variety of factors, including variations in ink drop weight, ink-substrate interactions, and variations caused by environmental factors. As a result, color calibration happens periodically, interrupts print production and results in color consistency degradation between calibration events.

### BRIEF DESCRIPTION OF THE DRAWINGS

FIG. 1 is a schematic of an example color calibration adjustment system of the present disclosure;

FIG. 2 is a flow chart of an example color calibration adjustment method of the present disclosure; and

FIG. 3 is a flow chart of an example color calibration adjustment method of the present disclosure.

### DETAILED DESCRIPTION

Color calibration methods are usable only between print jobs, but may not be used for improving within-job color consistency. In addition, due to resources required for performing color calibration (e.g., a substrate, ink, time, operator attention), the frequency of color calibration may only be as high as may be practically accommodated.

More frequent or on-the-fly color calibration may use a color camera or scanner to collect data during a print job. Doing so requires dedicated colorant patches to be printed (e.g., in margins of a print job), but may not be applied to workflows where full-bleed printing is required. In addition, the accuracy of cameras and scanners is more limited than dedicated color measurement devices such as spectrophotometers and, therefore, may not be applicable to more color-critical applications. Color measurements refer to an effect of a colorant on a substrate in terms of the colorant's resultant color.

Measuring ink drop weight using an ink drop weight (IDW) sensor (e.g., a Hewlett-Packard (HP) Drive Bubble Detect ink drop weight sensor) at print time and cross-linking IDW with an effective ink drop weight (eIDW) measured using a spectrophotometer enables color calibration to be updated continuously and reduces the frequency of performing color-measurement based color calibration, which improves color consistency form all types of printing from in-job via reprint to fleet and reduces waste due to print-based color calibration. IDWs are measured using an IDW sensor since IDWs concern colorant quantities, while eIDWs are obtained using a spectrophotometer since eIDWs concern an effect of colorants on a substrate in terms of a resulting color.

Examples described herein provide a device for and a method of determining an actual drop weight, determining an effective drop weight, and cross-linking the actual drop weight and the effective drop weight to adjust color calibration continuously in real-time and reduce a frequency of color measurement based color calibration. Thus, improving all types of color consistency from in-job via reprint to fleet and reducing waste due to print-based color calibration.

Examples described herein provide a device for and a method of adjusting color calibration where drop weight is measured using an IDW sensor and effective drop weight is measured using a spectrophotometer.

Examples described herein provide a device for and a method of inferring ink drop volume from in-printhead sensing or near-printhead sensing, where either type of sensing may occur at print time. Since drop volume measurement alone may not account for color changes, drop volume measurement, by itself, may not be directly suitable for color calibration.

Examples described herein provide a device for and a method that employ a combined approach to color calibration, where color measurement and drop weight detection are periodically cross-linked, which enables color calibration adjustments to be inferred from direct drop weight measurements and real-time color correction to be made without requiring dedicated calibration chart printing.

Examples described herein provide a device for and a method of improving various types of color consistency typically aided by color calibration (e.g., reprint and fleet consistency) and color consistency within single, long print jobs, which were previously beyond the reach of conventional color calibration in inkjet printing.

Examples described herein provide a device for and a method of keeping color calibration up to date during long runs or at higher frequencies than current print-measure solutions allow for.

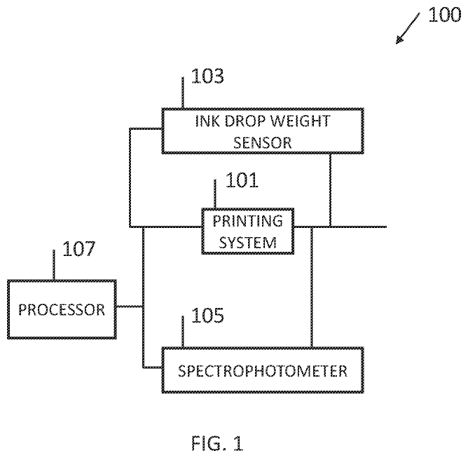

FIG. 1 is a schematic of an example color calibration adjustment system 100 of the present disclosure. In an example, the color calibration adjustment system 100 may include a printing system 101, an ink drop weight sensor 103 connected to the printing system 101, a spectrophotometer 105 connected to the printing system 101, and a processor 107 connected to the printing system 101, the ink drop weight sensor 103, and the spectrophotometer 105. In an example, a printing system may include a printer. In an example, a printer may include an inkjet printer, a scanning inkjet printer, and a page-wide array printer.

In an example, the printing system 101 includes at least one printhead. The ink drop weight sensor 103 measures an ink drop weight (IDW) of each printhead of the printing system 101. The ink drop weight sensor 103 may be located separately from (e.g., near) a printhead of the printing system 101 or in a printhead of the printing system 101. In an example, the ink drop weight sensor 103 may be a Hewlett-Packard (HP) Drive Bubble Detect ink drop weight sensor.

The spectrophotometer 105 may be located separately from the printing system 101 or in the printing system 101. The spectrophotometer 105 measures color printed by the printing system 101.

The processor 107 includes a color calibration method based on effective ink drop weight correction. For example, at calibration time, the processor 107 determines an effective ink drop weight and modifies the output of the printing system 101 based on changes in the effective ink drop weight between a previous reference state of the printing system 101 and a current state of the printing system 101. In an example, a change is between two ink drop weights on a single substrate type. The processor 107 determines an effective ink drop weight (eIDW) from color measurements made by the spectrophotometer 105. Thus, IDW measurements of the ink drop weight sensor 103 are used to emulate the eIDW determined from color measurements made by the spectrophotometer 105. An IDW represents a weight of an ink drop from a printhead of the printing system 101. An eIDW indicates an effect of an ink drop on a specific substrate. For example, a 10% change in an IDW may correspond to a 7% change in an eIDW on one substrate but a 12% change in the eIDW on another substrate due to a difference in ink-substrate penetration, spreading, etc. between the two substrates. To maintain color consistency on a substrate, the effect of an ink drop on the substrate must be kept constant. Thus, a change in an IDW must be translated to a specific and different eIDW on a substrate-by-substrate basis.

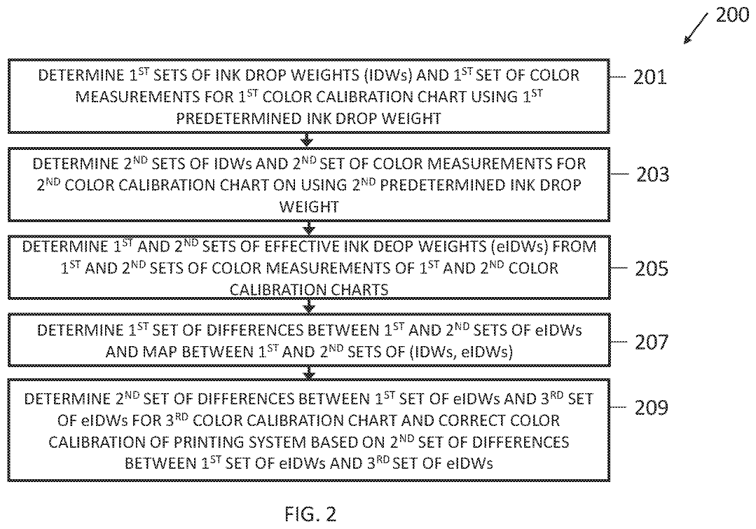

FIG. 2 is a flow chart of an example color calibration adjustment method 200 of the present disclosure.

At block 201, the method 200 begins. At block 201, a first set of ink drop weights (IDWs) and a first set of color measurements are determined for a first color calibration chart printed by a printing system using a first predetermined ink drop weight. The first color calibration chart includes first colorant ramps including first colorant patches with increasing levels of colorant coverage between adjacent first colorant patches for one or more colorants used in the printing system. The first set of IDWs (e.g., one IDW for each nozzle in the printing system, where a printhead may include one or more nozzles) may be measured using an IDW sensor while printing the first colorant patches of the first color calibration chart.

At block 203, a second set of IDWs and a second set of color measurements are determined for a second color calibration chart printed by the printing system using a second predetermined ink drop weight that is different from the first ink drop weight. The second color calibration chart includes second colorant ramps including second colorant patches with increasing levels of colorant coverage between adjacent second colorant patches for one or more colorants used in the printing system. The second set of IDWs (e.g., one IDW for each nozzle in the printing system, where a printhead may include one or more nozzles) may be measured using an IDW sensor while printing the second colorant patches of the second color calibration chart.

At block 205, the method 200 determines a first set of eIDWs and a second set of eIDWs from the color measurements of the first color calibration chart and the color measurements of the second color calibration chart, respectively. In an example, the first set of eIDWs may be considered to be at a nominal level. The color measurements may be made using a spectrophotometer.

At block 207, the method 200 determines a first set of differences of eIDWs (i.e., a first set of ΔeIDWs) between the first set of eIDWs and the second set of eIDWs, respectively, and a mapping between a set of (the first set of IDWs, the first set of eIDWs) and a set of (the second set of IDWs, the second set of eIDWs). In an example, the first set of ΔeIDWs may be determined using various color calibration methods. In an example the mapping between IDW and eIDW may be linear, polynomial, a radial basis function, and so on.

At block 209, the method 200 determines a second set of ΔeIDWs after a third printing by the printing system (e.g., using the printing system to print an actual print job) in a similar manner as the first set of ΔeIDWs was determined (e.g., a third set of IDWs are determined for the third printing) and corrects color calibration based on the second set of ΔeIDWs. In an example, the second set of ΔeIDWs may be determined from a difference between the second set of IDWs and the third set of IDWs (e.g., a first set of AIDWs).

Alternatively, a colorant verification of the printing system or a color calibration of the printing system may be initiated based on the second set of ΔeIDWs.

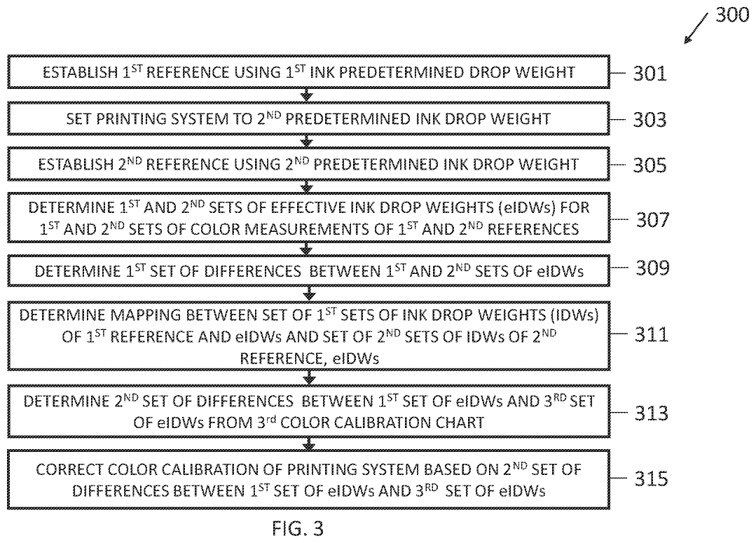

FIG. 3 is a flow chart of an example color calibration adjustment method 200 of the present disclosure.

At block 301, the method 300 begins. At block 301, a first reference is established for which color calibration may be done on a particular substrate using a first ink drop weight. For example, each nozzle in the printing system may be set to print with a first nozzle firing pulse width. For example, the first reference may be established by a first printing of a first color calibration chart by a printing system (e.g., first colorant ramps including first colorant patches with increasing levels of colorant coverage between adjacent first colorant patches for one or more colorants used in the printing system), measuring a first set of IDWs (e.g., one IDW for each nozzle in the printing system, where a printhead may include one or more nozzles) while printing for the first colorant patches of the first color calibration chart, and measuring colors of the first color calibration chart (e.g., using a spectrophotometer).

At block 303, the method 300 sets the printing system to a second ink drop weight that is different from the first ink drop weight. For example, each nozzle in the printing system may be set to print with a second nozzle firing pulse width that is different from the first nozzle firing pulse width that was used for establishing the first reference.

At block 305, the method 300 establishes a second reference using the second ink drop weight. For example, the second reference may be established by a second printing for printing a second color calibration chart by the printing system (e.g., second colorant ramps including second colorant patches with increasing levels of colorant coverage between adjacent second colorant patches for one or more colorants used in the printing system), measuring a second set of IDWs while printing the second colorant patches, and measuring colors of the second color calibration chart (e.g., using the spectrophotometer).

At block 307, the method 300 determines a first set of eIDWs and a second set of eIDWs from the color measurements of the first color calibration chart and the color measurements of the second color calibration chart, respectively. In an example, the first set of eIDWs may be considered to be at a nominal level.

At block 309, the method 300 determines a first set of differences of eIDWs (i.e., a first set of ΔeIDWs) between the first set of eIDWs and the second set of eIDWs, respectively. In an example, the first set of ΔeIDWs may be determined using various color calibration methods.

At block 311, the method 100 determines a mapping between a set of (the first set of IDWs, the first set of eIDWs) and a set of (the second set of IDWs, the second set of eIDWs). In an example the mapping between IDW and eIDW may be linear, polynomial, a radial basis function, and so on.

At block 313, the method 300 determines a second set of ΔeIDWs after a third printing by the printing system (e.g., using the printing system to print an actual print job) in a similar manner as the first set of ΔeIDWs was determined (e.g., a third set of IDWs are determined for the third printing). In an example, the second set of ΔeIDWs may be determined from a difference between the second set of IDWs and the third set of IDWs (e.g., a first set of AIDWs).

At block 315, the method 300 corrects color calibration based on the second set of ΔeIDWs. Alternatively, a colorant verification of the printing system or a color calibration of the printing system may be initiated based on the second set of AIDWs.

In an example, when a color calibration is initiated (e.g., by block 315 of the method 300 or by an operator of the printing system), a fourth color calibration chart may be printed, similarly as the first color calibration chart was printed. A fourth set of IDWs may be measured using an IDW sensor while the fourth color calibration chart is printed, similarly as the first set of IDWs was measured. The colors of the fourth color calibration chart may be measured using a spectrophotometer. A fourth set of eIDWs may be determined from the color measurements of the fourth color calibration chart. Color calibration may be performed based on the color measurements of the first color calibration chart and the fourth color calibration chart, where a particular method may be used to perform color calibration. The IDW to eIDW mapping may then be updated based on the fourth sets of IDWs and eIDWs.

In an example, how IDWs and eIDWs relate for different substrate categories may be determined off-line. This may render optional the steps of setting a printing system to a second ink drop weight and establishing a second reference, but may only apply where substrate categories are homogeneous and where the substrate categories may be well sampled in advance (e.g., for aqueous technical or aqueous graphics printing systems, but may not apply for Latex printing systems).

Updating the mapping of IDW to eIDW may be done by different methods. In an example, a mapping of IDW to eIDW may be determined from data concerning the first reference and a subsequent color calibration operation. In an example, the mapping of IDW to eIDW may be done using all available IDW-eIDW data at the current time for a given media. In an example, when all available data is used, the data may be filtered (e.g., outlier removal) or weighted (e.g., more recent data may be given more weight).

Variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method of adjusting color calibration, comprising:
detecting a plurality of sets of ink drop weights; and
adjusting color calibration based on a comparison of the plurality of sets of ink drop weights and a plurality of sets of effective ink drop weights.

2. The method of claim 1, wherein detecting a plurality of sets of ink drop weights comprises:
determining a first set of ink drop weights (IDWs) and a first set of color measurements for a first color calibration chart printed by a printing system using a first predetermined ink drop weight; and
determining a second set of IDWs and a second set of color measurements for a second color calibration chart printed by the printing system using a second predetermined ink drop weight that is different from the first predetermined ink drop weight.

3. The method of claim 2, wherein the adjusting color calibration based on a comparison of the plurality of sets of ink drop weights and a plurality of sets of effective ink drop weights comprises:
determining a first set of effective IDWs (eIDWs) and a second set of eIDWs from the first set of color measurements of the first color calibration chart and the second set of color measurements of the second color calibration chart, respectively; and
determining a first set of differences of eIDWs (ΔeIDWs) between the first set of eIDWs and the second set of eIDWs, respectively, and a mapping between a set including the first set of IDWs and the first set of eIDWs and a set including the second set of IDWs and the second set of eIDWs.

4. The method of claim 3, further comprising determining a second set of ΔeIDWs after a third printing by the printing system and correcting color calibration based on the second set ofΔAeIDWs.

5. The method of claim 2, wherein at least one of the first color calibration chart or the second color calibration chart comprises colorant ramps including colorant patches having different levels of colorant coverage between adjacent colorant patches for one or more colorants used in the printing system.

6. The method of claim 2, further comprising measuring the first set of IDWs and the second set of IDWs using an IDW sensor and measuring the first set of eIDWs and the second set of eIDWs using a spectrophotometer while printing first colorant patches of the first color calibration chart and second colorant patches of the second color calibration chart, respectively.

7. The method of claim 3, wherein the mapping between the set including the first set of IDWs and the first set of eIDWs and the set including the second set of IDWs and the second set of eIDWs comprises a linear mapping, a polynomial mapping, or a radial basis function mapping.

8. The method of claim 4, further comprising:
determining a third set of IDWs for the third printing; and
determining the second set of ΔeIDWs from a difference between the second set of IDWs, the third set of IDWs, and a mapping between IDWs and eIDWs.

9. The method of claim 4, further comprising initiating one of a colorant verification of the printing system and a color calibration of the printing system based on the second set of ΔeIDWs.

10. A color calibration adjustment system, comprising:
a printing system having an output;
an ink drop weight (IDW) sensor connected to the printing system;
a spectrophotometer connected to the printing system; and
a processor connected to the printing system, the ink drop weight sensor, and the spectrophotometer to determine an effective ink drop weight (eIDW) and modify the output of the printing system based on differences in the eIDW (ΔeIDWs) between a previous reference state of the printing system and a current state of the printing system.

11. The system of claim 10, wherein the processor causes the printing system to generate a first color calibration chart and a second color calibration chart, at least one of which comprises colorant ramps including colorant patches having different levels of colorant coverage between adjacent colorant patches for one or more colorants used in the printing system.

12. The system of claim 11, wherein the IDW sensor measures the first set if IDWs and the second set of IDWs and the spectrophotometer measures a first set of eIDWs and a second set of eIDWs while the printer prints colorant patches of the first color calibration chart and the second color calibration chart, respectively.

13. The system of claim 12, wherein the processor further determines a mapping between a set including the first set of IDWs and a first set of eIDWs and a set including the second set of IDWs and a second set of eIDWs, wherein the mapping comprises a linear mapping, a polynomial mapping, or a radial basis function mapping.

14. The system of claim 12, wherein the processor determines a third set of IDWs for a third printing and determines a second set of ΔeIDWs from a difference between the second set of IDWs and the third set of IDWs.

15. The system of claim 14, wherein the processor further initiates one of a colorant verification of the printer and a color calibration of the printer based on the second set of ΔeIDWs.
